(19) United States
(12) Patent Application Publication
(10) Pub. No.: US 2023/0382240 A1
(43) Pub. Date: Nov. 30, 2023

(54) CONTROL APPARATUS FOR VEHICLE

(71) Applicant: Toyota Jidosha Kabushiki Kaisha, Toyota-shi (JP)

(72) Inventors: Yuji Yamaya, Okazaki-shi (JP); Tomoya Nagano, Numazu-shi (JP)

(73) Assignee: Toyota Jidosha Kabushiki Kaisha, Toyota-shi (JP)

(21) Appl. No.: 18/320,286

(22) Filed: May 19, 2023

(30) Foreign Application Priority Data
May 24, 2022 (JP) 2022-084860

(51) Int. Cl. B60L 15/20; B60L 15/30

(52) U.S. Cl. CPC B60L 15/2018; B60L 15/30; B60L 2240/642; B60L 2240/423

(57) ABSTRACT

A control apparatus for a vehicle that includes an electric motor and a parking lock mechanism for stopping rotation in a power transmission path between the electric motor and drive wheels. The parking lock mechanism includes: a parking gear, a lock tooth that is to mesh with the parking gear and an actuator for moving the lock tooth. When a shift operation position is switched to a parking position, the lock tooth is moved by the actuator to mesh with the parking gear. When the shift operation position is switched from the parking position to another position in a state in which the vehicle is stopped, the electric motor outputs a torque acting in a rotational direction opposite to a direction of rotation of the drive wheels due to a gradient of a road surface, and the outputted torque is increased until rotation of the electric motor is detected.

This application claims priority from Japanese Patent Application No. 2022-084860 filed on May 24, 2022, the disclosure of which is herein incorporated by reference in its entirety.

### FIELD OF THE INVENTION

The present invention relates to techniques for appropriately release a parking lock mechanism when a shift lever is moved from a parking position to another shift position on a sloped road.

### BACKGROUND OF THE INVENTION

When a shift lever is moved from a parking position (P position) to another shift position (such as D position and R position) so as to switch a shift range of a vehicle from a parking range (P range) to another range (such as D range and R range) in a state in which the vehicle is parked on a sloped road, a load applied to a parking lock mechanism is increased, so that there is a risk that a load applied to an actuator that operates the parking lock mechanism could be increased, and a shock caused by a torsion of a wheel could be increased. On the other hand, JP-2007-112409A discloses that, when the parking lock mechanism cannot be released by the actuator, a traction motor is driven to rotate a parking gear, thereby reducing the load applied to the actuator and releasing the parking lock mechanism.

### SUMMARY OF THE INVENTION

By the way, in the above-identified Japanese Patent Application Publication, when it is detected that the shift lever has been moved to another shift position other than the parking position, the actuator of the parking lock mechanism is driven. In this instance, in a case in which the parking lock mechanism cannot be released by the actuator, the traction motor is driven. Consequently, the actuator operating the parking lock mechanism is driven at an increased number of times, thereby increasing an electric-power consumption amount and there is a concern that durability of the actuator could be reduced.

The present invention was made in view of the background art described above. It is therefore an object of the present invention to provide a control apparatus for a vehicle, wherein the control apparatus is capable of releasing a parking lock mechanism without increasing a number of times at which the actuator is driven, when the parking lock mechanism is to be released in a state in which the vehicle is parked on a sloped road.

The object indicated above is achieved according to the following aspects of the present invention.

According to a first aspect of the invention, there is provided a control apparatus for a vehicle that includes (i) drive wheels, (ii) an electric motor serving as a drive power source and (iii) a parking lock mechanism configured to mechanically stop rotation in a power transmission path between the electric motor and the drive wheels, wherein the parking lock mechanism includes (iii-1) a parking gear provided in the power transmission path, (iii-2) a lock tooth that is to mesh with the parking gear and (iii-3) an actuator configured to move the lock tooth, and wherein, when a shift operation position is switched to a parking position, the lock tooth is moved by the actuator to a meshing position to mesh with the parking gear whereby the parking lock mechanism is switched to a parking lock state in which rotation of the parking gear is inhibited by the lock tooth meshing with the parking gear. The control apparatus is configured, when the shift operation position is switched from the parking position to another position in a state in which the vehicle is stopped, to cause the electric motor to output a torque acting in an opposite rotational direction opposite to a direction of rotation of the drive wheels due to a gradient of a road surface, and to increase the torque outputted by the electric motor until rotation of the electric motor is detected.

According to a second aspect of the invention, in the control apparatus according to the first aspect of the invention, the control apparatus is configured, when the rotation of the electric motor is detected, to cause the actuator to move the lock tooth to a releasing position in which meshing of the lock tooth with the parking gear is released.

According to a third aspect of the invention, in the control apparatus according to the first or second aspect of the invention, the control apparatus is configured to determine the opposite rotational direction in which the outputted torque is to act, based on a direction of the gradient of the road surface, wherein the control apparatus is configured, after the parking lock mechanism is switched to the parking lock state in process of parking the vehicle, to determine the direction of the gradient of the road surface, based on a change of a rotational angle of the electric motor or a change of a rotational angle of a wheel of the vehicle, which are caused upon release of depression of a brake pedal of the vehicle.

According to a fourth aspect of the invention, in the control apparatus according to the first aspect of the invention, the control apparatus is configured, when the shift operation position is switched from the parking position to the other position, to determine whether the road surface is sloped or not, wherein the control apparatus is configured, when the road surface is sloped, to cause the electric motor to output the torque acting in the opposite rotational direction opposite to the direction of the rotation of the drive wheels due to the gradient of the road surface.

In the control apparatus according to the first aspect of the invention, when the shift operation position is switched from the parking position to another position, the electric motor is caused to output the torque acting in the opposite rotational direction opposite to the direction of the rotation of the drive wheels due to the gradient of the road surface, and the torque outputted by the electric motor is increased until the rotation of the electric motor is detected. Therefore, even in a case in which the vehicle is stopped on a sloped road so that a load acting between the parking gear and the lock tooth meshing with the parking gear is large, the load acting between the parking gear and the lock tooth is reduced with the torque of the electric motor being increased until the rotation of the electric motor is detected, and becomes zero or substantially zero when the rotation of the electric motor is detected. Thus, the load on the actuator is reduced because the meshing of the lock tooth with the parking gear is released in the parking lock mechanism in this state in which the load acting between the parking gear and the lock tooth is zero or substantially zero. Further, a torsion caused in the power transmission path between the parking gear and the drive wheels is cancelled by the rotation of the electric motor, so that it is possible to suppress a shock, which could be caused due to the torsion in the power transmission path, when the vehicle is started. Still further, in this control apparatus, a process of driving the actuator and determining whether it is possible to release the meshing of the lock tooth with the parking gear is not required so that a number of times at which the actuator is operated is not increased, and accordingly an electric power consumption is also reduced. Moreover, the load applied to the actuator is reduced whereby deterioration in durability of the actuator is also suppressed.

In the control apparatus according to the second aspect of the invention, when the rotation of the electric motor is detected, the actuator is caused to move the lock tooth to the releasing position in which the meshing of the lock tooth with the parking gear is released. Thus, the load applied to the actuator is reduced whereby the deterioration in the durability of the actuator is suppressed.

In the control apparatus according to the third aspect of the invention, after the parking lock mechanism is switched to the parking lock state in process of parking the vehicle, the direction of the gradient of the road surface can be accurately determined based on the change of the rotational angle of the electric motor or the change of the rotational angle of the wheel of the vehicle, which are caused upon release of the depression of the brake pedal of the vehicle.

In the control apparatus according to the fourth aspect of the invention, when the shift operation position is switched from the parking position to the other position, it is determined whether the road surface is sloped or not, and, when the road surface is sloped, the electric motor is caused to output the torque acting in the opposite rotational direction opposite to the direction of the rotation of the drive wheels due to the gradient of the road surface. Therefore, when it is determined that the road surface is flat, the electric motor is avoided from outputting the torque whereby the electric power consumption is reduced.

The direction of the gradient of the road surface can be determined also based on the road gradient detected by a slop sensor. Further, the direction of the gradient of the road surface can be determined also based on an angular acceleration of the electric motor or the wheel relative to an accelerator opening degree during running of the vehicle on the road surface. Still further, the direction of the gradient of the road surface can be determined also based on the angular acceleration of the electric motor or the wheel relative to a brake operation amount during running of the vehicle on the road surface. Moreover, the direction of the gradient of the road surface can be determined also based on a level of an oil stored in an oil pan that is provided in a lower portion of a power transmission apparatus, or based on changes of a stroke amount (displacement) of a front axle suspension supporting a front axle and a stroke amount (displacement) of a rear axle suspension supporting a rear axle.

### BRIEF DESCRIPTION OF THE DRAWINGS

FIG. 1 is a view schematically showing a structure of a drive system of a vehicle to which the present invention is applied;

FIG. 2 is a view showing an overall construction of a parking lock mechanism shown in FIG. 1;

FIG. 3 is a cross sectional view showing an internal structure of a cam mechanism shown in FIG. 2;

FIG. 4 is a functional block diagram explaining various vehicle information inputted to an electronic control apparatus and also control functions of the electronic control apparatus;

FIG. 5 is a time chart showing a behavior of the vehicle when the vehicle is parked on a sloped road;

FIG. 6 is a time chart showing the behavior of the vehicle during running of the vehicle on an upward sloped road;

FIG. 7 is a time chart showing the behavior of the vehicle when the vehicle is to be stopped on the upward sloped road;

FIG. 8 is a view showing a state in which the vehicle is stopped on the upward sloped road;

FIG. 9 is a view showing a relationship between a state of a road surface and a stroke amount of a front axle suspension and also a relationship between the state of the road surface and a stroke amount of a rear axle suspension;

FIG. 10 is a view showing a state of an oil stored in an oil pan when the vehicle is on a flat road;

FIG. 11 is a view showing the state of the oil stored in the oil pan when the vehicle is on an upward sloped road;

FIG. 12 a time chart showing the behavior of the vehicle, based on control operations performed by the electronic control apparatus; and

FIG. 13 is a flow chart showing a control routine executed by the electronic control apparatus.

### DETAILED DESCRIPTION OF PREFERRED EMBODIMENT

There will be described an embodiment of the present invention in details with reference to drawings. It is noted that figures of the drawings are simplified or deformed as needed, and each portion is not necessarily precisely depicted in terms of dimension ratio, shape, angle, etc, for easier understanding of the embodiment.

### Embodiment

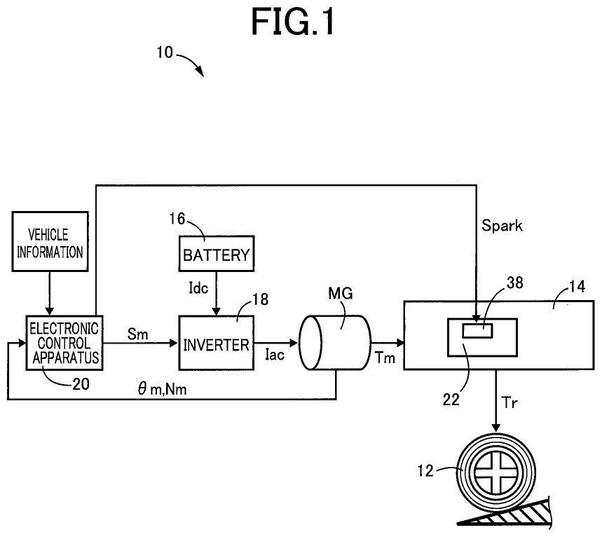

FIG. 1 is a view schematically showing a structure of a drive system of a vehicle 10 to which the present invention is applied. The vehicle 10 includes an electric motor MG serving as a drive power source for enabling the vehicle 10 to run, drive wheels 12 and a power transmission apparatus 14 provided between the electric motor MG and the drive wheels 12. Thus, the vehicle 10 is an electric vehicle having the drive power source in the form of the electric motor MG.

The electric motor MG is a motor generator having a function serving as a motor configured to generate a mechanical power from an electric power supplied from a battery 16 and also a function serving as a generator configured to generate the electric power from the mechanical power. It is noted the power corresponds to a torque and a force unless otherwise specified.

The electric motor MG is connected to the battery 16 through an inverter 18. The inverter 18 is controlled by the electronic control apparatus 20 whereby an MG torque Tm as an output torque of the electric motor MG is controlled. The MG torque Tm serves as a power driving torque when acting as a positive torque for acceleration, with the electric motor MG being rotated in a forward direction corresponding to a running direction of the vehicle 10. The MG torque Tm serves as a regenerative torque when acting as a negative torque for deceleration, with the front electric motor MG being rotated in the forward direction.

The electric motor MG generates the power for driving the vehicle 10, owing to the electric power supplied from the battery 16 through the inverter 18. Further, the electric motor MG is configured to be able to generate the electric power by a driven power inputted from the drive wheels 12. The electric power generated by the electric motor MG is supplied to the battery 16 through the inverter 18 so as to be stored in the battery 16.

The inverter 18 converts a DC current supplied from the battery 16, to an AC current (three-phase AC current), and supplies the AC current to the electric motor MG. Further, the inverter 18 converts the AC current generated by the electric motor MG, to the DC current, and stores the DC current in the battery 16.

The power transmission apparatus 14 defines a power transmission path between the electric motor MG and the drive wheels 12, and includes a stepped or continuously variable transmission, a differential gear device and a drive shaft, so as to transmit the MG torque Tm outputted by the electric motor MG, toward the drive wheels 12.

The power transmission apparatus 14 includes a parking lock mechanism 22 that is to be operated when a shift range of the vehicle 10 is switched to a parking range (hereinafter referred to as “P range”).

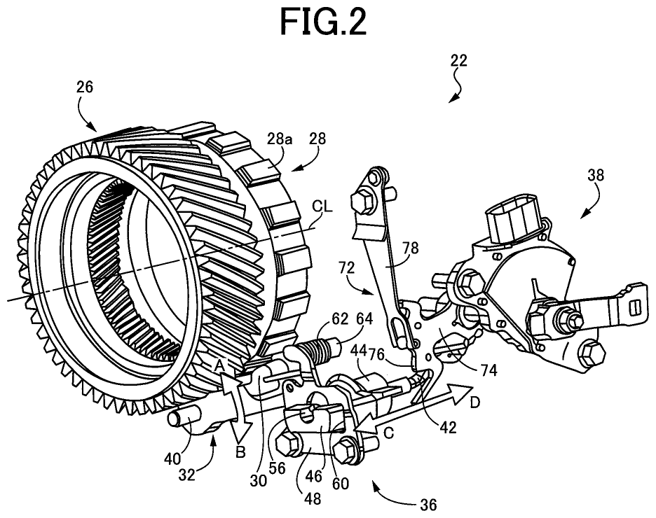

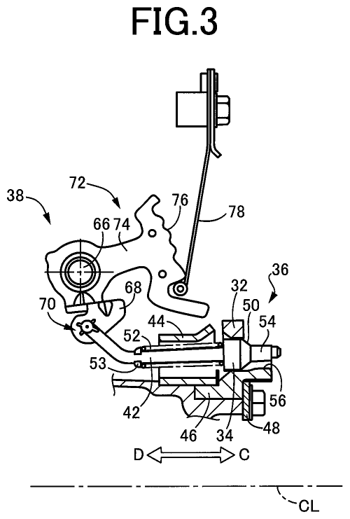

FIG. 2 is a view showing an overall construction of the parking lock mechanism 22 shown in FIG. 1. FIG. 3 is a cross sectional view showing an internal structure of a cam mechanism shown 36 in FIG. 2. The parking lock mechanism 22 includes a cam mechanism 36 and an actuator 38 configured to operate the cam mechanism 36. The cam mechanism 36 includes a parking gear 28 provided integrally with a drive gear 26, a parking pawl 32 provided with a lock tooth 30 that is to mesh with the parking gear 28, and a cam 34 (see FIG. 3) that is to be brought into contact with the parking pawl 32, and is configured to cause the parking pawl 32 to be pivoted, by moving the cam 34 in parallel to an axis CL of the parking gear 28.

The parking gear 28 is disposed in the power transmission path between the electric motor MG and the drive wheels 12. The parking gear 28 has a plurality of meshing teeth 28a that are to mesh with the lock tooth 30 of the parking pawl 32. The meshing teeth 28a are provided on an outer circumferential surface of the parking gear 28, and are spaced apart from each other at equal angular intervals in a circumferential direction of the parking gear 28. When the lock tooth 30 meshes with the meshing teeth 28a, the parking gear 28 and the drive gear 26 are inhibited from being rotated, so as to stop rotations of the drive wheels 12 that are mechanically connected to the drive gear 26.

The parking pawl 32 is an elongated plate member, and is provided with the lock tooth 30 that is to mesh with the meshing teeth 28a of the parking gear 28. The parking pawl 32 is pivotable about a pivot shaft 40 that is parallel to the axis CL. When the parking pawl 32 is pivoted in a direction indicated by arrow A shown in FIG. 2, the lock tooth 30 is caused to mesh with the meshing teeth 28a whereby the parking lock mechanism 22 is placed in its lock state. On the other hand, when the parking pawl 32 is pivoted in a direction indicated by arrow B shown in FIG. 2, the meshing of the lock tooth 30 with the meshing teeth 28a is released whereby the parking lock mechanism 22 is placed in its unlock state. Thus, with the parking pawl 32 being pivoted, the parking pawl 32 switches between the lock state and the unlock state of the parking lock mechanism 22. In the lock state, the lock tooth 30 meshes with the meshing teeth 28a of the parking gear 28. In the unlock state, the meshing of the lock tooth 30 with the meshing teeth 28a is released.

There will be next described a structure of the cam mechanism 36 with reference to FIG. 3 that is a cross sectional view showing the internal structure of the cam mechanism 36. It is noted that FIG. 3 shows the lock state (meshing state) of the parking lock mechanism 22 in which the lock tooth 30 of the parking pawl 32 is positioned in a meshing position to mesh with the meshing teeth 28a of the parking gear 28.

The cam mechanism 36 includes the above-described cam 34 that is to be brought into contact with the parking pawl 32, a parking rod 42 that is to be moved in parallel to the axis CL so as to move the cam 34 provided in a distal-end side portion of the parking rod 42, a cover 44 that covers the parking rod 42, a parking sleeve 46 that guides the cam 34, a plate 48 that holds the parking sleeve 46, and a cam spring 52 that biases or constantly forces the cam 34.

The cam 34 is an annular-shaped member having a tapered surface 50, and is provided in the distal-end-side portion of the parking rod 42. Specifically, the parking rod 42 is inserted in the cam 34, such that the cam 34 is movable relative to the parking rod 42 in an axial direction of the parking rod 42. The cam spring 52 consists of a coil spring through which the parking rod 42 extends, and is disposed between the cam 34 and a ring 53 that is unmovably fixed on the parking rod 42 so as to bias or constantly forces the cam 34 toward a distal end of the parking rod 42. A large diameter portion 54 is provided in a distal end portion of the parking rod 42 so as to limit movement of the cam 34 in the axial direction. Thus, the cam 34 is constantly forced by the cam spring 52 toward the distal end of the parking rod 42, and the cam 34 is in contact with the large diameter portion 54 provided in the distal end portion of the parking rod 42, in a normal state.

The parking rod 42 is movable by the actuator 38 in opposite directions parallel to the axial direction of the parking rod 42, i.e., directions indicated by arrows C and D shown in FIGS. 2 and 3. FIG. 3 shows a state in which the parking rod 42 has been moved in the direction of the arrow C, i.e., in the direction toward the plate 48. The parking sleeve 46 is provided with a guide groove 56 that is to guide the cam 34 when the cam 34 is moved together with the parking rod 42. Thus, the cam 34 is to be moved along the guide groove 56.

The plate 48 has a through-hole 60 through which the parking sleeve 46 extends. The plate 48 is provided with a support shaft 64 that supports a return spring 62 (see FIG. 2). The return spring 62 is in contact with the parking pawl 32, and biases or constantly forces the parking pawl 32 in an unlock direction that releases the meshing of the lock tooth 30 of the parking pawl 32 with the meshing teeth 28a of the parking gear 28. Therefore, when the parking lock mechanism 22 is to be switched from the lock state to the unlock state, the parking pawl 32 is quickly pivoted in the unlock direction by the return spring 62. Further, owing to the return spring 62, it is possible to prevent switching of the parking lock mechanism 22 to the lock state, which is against an intention of a driver of the vehicle 10.

The actuator 38 rotates a rotary shaft 66 (see FIG. 3) so as to move the parking rod 42 in the axial direction. The rotary shaft 66 is connected through an intermediate member 68 to an axially end portion of the parking rod 42 that is remote from the above-described distal-end side portion in which the cam 34 is disposed. Therefore, with rotation of the rotary shaft 66, a position of a connection portion 70 connecting between the intermediate member 68 and the parking rod 42 is changed, and the parking rod 42 and the cam 34 are moved in the axial direction, depending on the position of the connection portion 70.

The rotary shaft 66 is provided with a detent mechanism 72. The detent mechanism 72 includes a detent plate 74 that is to be moved together with the rotary shaft 66 and a detent spring 78 that is pressed against a corrugated surface 76 of the detent plate 74. A distal end portion of the detent spring 78 is pressed against the corrugated surface 76 in which peaks and valleys are alternately arranged. When the rotary shaft 66 has been rotated to an angular position corresponding to a desired shift position, the distal end portion of the detent spring 78 is moved to a corresponding one of the above-described valleys of the corrugated surface 76, which corresponds to the desire shift position.

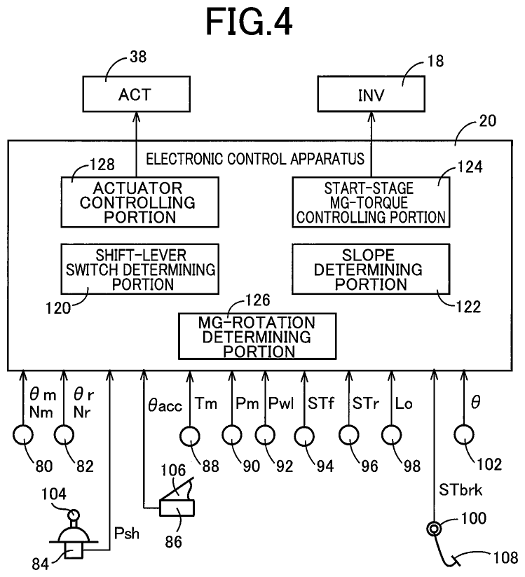

When a shift lever 104 (see FIG. 4) is moved so as to switch a shift operation position Psh to a parking position (hereinafter referred to as “P position”), the parking pawl 32 is pivoted by the actuator 38 about the pivot shaft 40 in counterclockwise direction, i.e., in a direction indicated by the arrow A in FIG. 2, whereby the lock tooth 30 is moved to the meshing position to mesh with the parking gear 28. In this instance, since the parking gear 28 is mechanically connected to the drive wheels 12, rotations of the parking gear 28 and the drive wheels 12 are inhibited with the meshing of the lock tooth 30 with the parking gear 28. Thus, the parking lock mechanism 22 is placed in the parking lock state (parking lock ON) that inhibits rotations of the drive wheels 12, whereby the shift range of the vehicle 10 is switched to the P range.

Further, when the shift operation position Psh is switched to a shift position other than the P position, from the parking lock state of the parking lock mechanism 22, the parking pawl 32 is pivoted by the actuator 38 about the pivot shaft 40 in clockwise direction, i.e., in a direction indicated by the arrow B in FIG. 2, whereby the meshing of the lock tooth 30 with the parking gear 28 is released. In this instance, the parking gear 28 is allowed to be rotated so that the parking lock mechanism 22 is switched to the parking unlock state (parking lock OFF) whereby the sift range is switched from the P range to another shift range.

As described above, the parking pawl 32 is pivoted by the actuator 38 about the pivot shaft 40. The actuator 38 includes, for example, an electric motor that is to be driven in accordance with a command signal Spark outputted from the electronic control apparatus 20. For example, when the electronic control apparatus 20 outputs the command signal Spark requesting the parking lock mechanism 22 to be switched to the parking lock state, the parking pawl 32 is rotated by the actuator 38 in the direction indicated by the arrow A in FIG. 2. In this instance, with the lock tooth 30 meshing with the parking gear 28, the parking gear 28 and the drive wheels 12 are inhibited from being rotated.

On the other hand, the electronic control apparatus 20 outputs the command signal Spark requesting the parking lock mechanism 22 to be switched to the parking unlock state, the parking pawl 32 is rotated by the actuator 38 in the direction indicated by the arrow B in FIG. 2. In this instance, the meshing of the lock tooth 30 with the parking gear 28 is released whereby the parking gear 28 and the drive wheels 12 are allowed to be rotated.

The electronic control apparatus 20 executes various controls such as a control for controlling running of the vehicle 10. The electronic control apparatus 20 controls the MG torque Tm of the electric motor MG, for example, based on an MG rotational angle θm and an MG rotational speed Nm.

The electronic control apparatus 20 includes a so-called microcomputer incorporating a CPU, a ROM, a RAM and an input-output interface. The CPU performs various control operations of the vehicle 10, by processing various input signals, according to control programs stored in the ROM, while utilizing a temporary data storage function of the RAM. The electronic control apparatus 20 may be constituted by two or more control units exclusively assigned to perform respective different control operations such as an electric-motor control operation and a brake control operation, as needed.

The electronic control apparatus 20 is configured to receive various input signals based on values detected by respective sensors provided in the vehicle 10. FIG. 4 is a functional block diagram explaining the various vehicle information inputted to the electronic control apparatus 20 and also control functions of the electronic control apparatus 20.

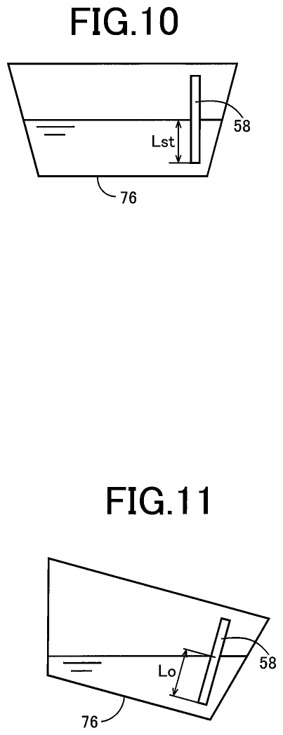

Specifically, the electronic control apparatus 20 receives: an output signal of an MG rotational-angle sensor 80 indicative of an MG rotational angle θm [deg] and an MG rotational speed Nm [rpm] of the electric motor MG; an output signal of a wheel rotational-angle sensor 82 indicative of a wheel rotational angle θr [deg] and a wheel rotational speed Nr [rpm] of each of wheels (including the drive wheels 12), an output signal of a shift position sensor 84 indicative of the shift operation position Psh that is an operation position of the shift lever 104; an output signal of an accelerator opening-degree sensor 86 indicative of an accelerator opening degree θacc [%] representing an amount of operation of an accelerator pedal 106; an output signal of an MG torque sensor 88 indicative of the MG torque Tm [Nm] of the electric motor MG; an output signal of a master-cylinder pressure sensor 90 indicative of a master-cylinder hydraulic pressure Pm [Pa] of a brake master cylinder; an output signal of a wheel-cylinder pressure sensor 92 indicative of a wheel hydraulic pressure Pwl [Pa] of each brake wheel cylinder for adjusting a brake force of a brake provided for a corresponding one of the wheels; an output signal of a front-axle-suspension stroke sensor 94 indicative of a stroke amount STf [mm] of a front axle suspension; an output signal of a rear-axle-suspension stroke sensor 96 indicative of a stroke amount STr [mm] of a rear axle suspension; an output signal of an oil level sensor 98 indicative of an oil level Lo [mm] that is a height of a surface of an oil stored in an oil pan 152 (see FIGS. 10 and 11) of the power transmission apparatus 14; an output signal of a brake sensor 100 indicative of a stroke amount STbrk [mm] of a brake pedal 108; and an output signal of a slope sensor 102 indicative of a road gradient θ[deg] and a direction of the road gradient θ.

The electronic control apparatus 20 generates various output signals to the various devices (such as the inverter 18 and the actuator 38) provided in the vehicle 10, wherein the various output signals include a command signal Sm for controlling the electric motor MG and a command signal Spark for controlling the actuator 38.

In the vehicle 10 constructed as described above, when depression of the brake pedal 108 is released without operating a parking brake after the shift lever 104 has been operated to be moved to the parking position (P position) on a sloped road, a rotary member (such as a drive shaft) constituting the power transmission path between the parking gear 28 and the drive wheels 12 is twisted or torsioned depending on the road gradient θ, whereby a torsion torque Ttw based on torsion of the rotary member is generated. If the shift lever 104 is operated to be moved to a running position (D position or R position) in a state in which the brake pedal 108 is depressed, for starting the vehicle 10, a load applied to the actuator 38 is increased because a resistance force generated between the parking gear 38 and the lock tooth 30 of the parking pawl 32 is large. Further, when the meshing of the lock tooth 30 with the parking gear 28 is released by operation of the actuator 38, there is a risk that a shock could be generated due to release of the torsion torque Ttw.

In the present embodiment, when the shift operation position Psh is switched from the P position to another shift position in a state in which the vehicle 10 is stopped, for starting the vehicle 10, the electronic control apparatus 20 determines whether a road surface on which the vehicle 10 is stopped is sloped or not. When the road surface is sloped, the electronic control apparatus 20 causes the electric motor MG to output the torque MG torque Tm acting in an opposite rotational direction opposite to a direction of rotation of the drive wheels 12 due to the road gradient θ, and increases the MG torque Tm outputted by the electric motor MG until rotation of the electric motor MG is detected. Hereinafter, there will be described a control for starting the vehicle 10 from a state in which the vehicle 10 is parked on a sloped road.

For executing the control for starting the vehicle 10 from the state in which the vehicle 10 is parked on the sloped road, the electronic control apparatus 20 functionally includes a shift-lever switch determining means in the form of a shift-lever switch determining portion 120, a slope determining means in the form of a slope determining portion 122, a start-stage MG-torque controlling means in the form of a start-stage MG-torque controlling portion 124, an MG-rotation determining means in the form of an MG-rotation determining portion 126, and an actuator controlling means in the form of an actuator controlling portion 128.

The shift-lever switch determining portion 120 is configured to determine whether the shift lever 104 is operated by the vehicle driver to be moved from the P position as a vehicle parking position to the D or R position as a vehicle running position, or not. The shift-lever switch determining portion 120 determines that the shift lever 104 has been moved from the P position to the D or R position, when detecting that the shift operation position Psh of the shift lever 104 detected by the shift position sensor 84 has been switched from the P position to the D or R position.

The slope determining portion 122 is configured, when it is determined that the shift operation position Psh has been switched from the P position to the D or R position, to determine whether the road surface on which the vehicle 10 is stopped is sloped or not. When the road surface is sloped, the slope determining portion 122 determines the direction of the road gradient θ that corresponds to a direction of change of the road surface relative to direction of running of the vehicle 10. The road gradient θ is a positive value when the road surface is sloped upward, and is a negative value when the road surface is sloped downward. In other words, the determination of direction of the road gradient θ corresponds to determination as to whether the road surface is sloped upward or sloped downward.

The slope determining portion 122 determines whether the road surface is sloped or not and determines the direction of the road gradient θ, by taking account of, for example, downward movement of the vehicle 10, which is caused in process of parking the vehicle 10. The slope determining portion 122 determines whether the road surface is sloped or not and determines the direction of the road gradient θ (namely, whether the road surface is sloped upward or sloped downward), based on a change of the MG rotational angle θm of the electric motor MG that is cased when the depression of the brake pedal 108 is released after the parking lock mechanism 22 has been placed into the lock state in process of parking the vehicle 10.

When the vehicle 10 is to be parked, normally, the vehicle driver depresses the brake pedal 108 to stop the vehicle 10 and then operatively moves the shift lever 104 to the P position to place the parking lock mechanism 22 into the parking lock state. Then, the vehicle driver releases the depression of the brake pedal 108. In this instance, if the vehicle 10 is on a sloped road, the vehicle 10 is moved downward until the lock tooth 30 of the parking pawl 32 meshes with the parking gear 28.

After the vehicle driver releases the depression of the brake pedal 108, the slope determining portion 122 determines that the road surface is sloped, if the change of the MG rotational angle θm due to the downward movement of the vehicle 10 is detected. In this instance, the slope determining portion 122 determines the direction of the road gradient θ, based on a direction of the change of the MG rotational angle θm which is caused due to the downward movement of the vehicle 10. The MG rotational angle θm is changed in a reverse rotation direction when the road surface is sloped upward, and is changed in a forward rotation direction when the road surface is sloped downward, for example. Therefore, the slope determining portion 122 determines that the road surface is sloped upward when the MG rotational angle θm is changed in the reverse rotation direction, and determines that the road surface is sloped downward when the MG rotational angle θm is changed in the forward rotation direction.

Further, the slope determining portion 122 can determine whether the road surface is sloped or not and determine the direction of the road gradient θ, also based on the wheel rotational angle θr of each wheel detected by the wheel rotational-angle sensor 82, in place of the MG rotational angle θm of the electric motor MG. The wheel rotational angle θr may be not only the wheel rotational angle θr of each of the drive wheels 12 but also the wheel rotational angle θr of a driven wheel other than the drive wheels 12. The determination as to whether the road surface is sloped or not and determination of the direction of the road gradient θ, based on the wheel rotational angle θr, are made in substantially the same manner as the above-described determinations based on the MG rotational angle θm, so that their descriptions are not provided.

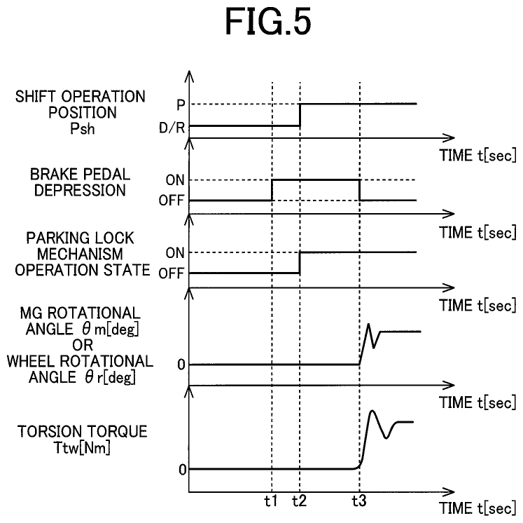

FIG. 5 is a time chart showing a behavior of the vehicle 10 when the vehicle 10 is parked on a sloped road. In FIG. 5, horizontal axes represent a time t [sec], while vertical axes represent the shift operation position Psh, the presence or absence of the depression of the brake pedal 108, the operation state of the parking lock mechanism 22, the MG rotational angle θm [deg] of the electric motor MG or the wheel rotational angle θr [deg], and the torsion torque Ttw [Nm]. It is noted that the torsion torque Ttw corresponds to a torque accumulated in a rotary member (such as a drive shaft) which is torsioned and which constitutes the power transmission path between the parking gear 28 and the drive wheels 12.

In FIG. 5, a time point t1 is a point to time at which the brake pedal 108 is depressed (brake pedal ON), to stop the vehicle 10. At a time point t2 at which a predetermined time has elapsed from the time point t1, the vehicle 10 is stopped, and the shift operation position Psh of the shift lever 104 is switched from the D or R position to the P position, for parking the vehicle 10. With the shift operation position Psh being switched to the P position, the parking lock mechanism 22 is switched from the parking unlock state (parking lock OFF) to the parking lock state (parking lock ON). At a time point t3, the depression of the brake pedal 108 is released (brake pedal OFF) after the parking lock mechanism 22 has been switched to the parking lock state. In this instance, since the vehicle is on the sloped road, the vehicle 10 is moved downward until the lock tooth 30 of the parking pawl 32 meshes with the parking gear 28, so that the MG rotational angle θm and the wheel rotational angle θr are changed. With the change of the MG rotational angle θm or the wheel rotational angle θr being detected, it is determined that the road surface is sloped. Further, it is also determined the direction of the road gradient θ, namely, whether the sloped road is sloped upward or sloped downward, based on the direction of change of the MG rotational angle θm or the direction of change of the wheel rotational angle θr. Further, a rotary element (such as a drive shaft) constituting the power transmission path between the parking gear 28 and the drive wheels 12 is twisted or torsioned since the vehicle 10 is on the sloped road, so that the torsion torque Ttw is generated owing to the torsion of the rotary element.

The determination as to whether the road surface is sloped or not and the determination of the direction of the road gradient θ can be made by other determination methods, which will be described below.

Whether the road surface is sloped or not and the direction of the road gradient θ can be determined, for example, based on an MG angular acceleration αm, i.e., a rate of change of the MG rotational speed Nm, or a wheel angular acceleration αr, i.e., a rate of change of the wheel rotational speed Nr, relative to the accelerator opening degree θacc representing the amount of operation of the accelerator pedal 106 during running of the vehicle 10 on the road surface on which the vehicle 10 is to be parked.

Where the MG angular acceleration αm or the wheel angular acceleration αr with a predetermined accelerator opening degree θacc during running of the vehicle 10 on a flat road is set to a reference angular acceleration αst, the MG angular acceleration αm or the wheel angular acceleration αr with the predetermined accelerator opening degree θacc during running of the vehicle 10 on an upward sloped road is lower than the reference angular acceleration αst. On the other hand, the MG angular acceleration αm or the wheel angular acceleration αr with the predetermined accelerator opening degree θacc during running of the vehicle 10 on a downward sloped road is higher than the reference angular acceleration αst.

The slope determining portion 122 calculates the MG angular acceleration am of the electric motor MG, based on the change of the MG rotational speed Nm during running of the vehicle 10, and determines that the road surface is a sloped road when the calculated MG angular acceleration αm is deviated from the reference angular acceleration αst (that is predetermined for each level of the accelerator opening degree θacc) during running on a flat road, by at least a predetermined value. In this instance, the slope determining portion 122 determines that the sloped road is sloped upward when the MG angular acceleration αm is lower than the reference angular acceleration αst, and determines that the sloped road is sloped downward when the MG angular acceleration αm is higher than the reference angular acceleration αst.

Alternatively, the slope determining portion 122 calculates the wheel angular acceleration αr, based on the change of the wheel rotational speed Nr during running of the vehicle 10, and determines that the road surface is a sloped road when the calculated wheel angular acceleration αr is deviated from the reference angular acceleration αst (that is predetermined for each level of the accelerator opening degree θacc) during running on a flat road, by at least a predetermined value. In this instance, the slope determining portion 122 determines that the sloped road is sloped upward when the wheel angular acceleration αr is lower than the reference angular acceleration αst, and determines that the sloped road is sloped downward when the wheel angular acceleration αr is higher than the reference angular acceleration αst. The reference angular acceleration αst (that is predetermined for each level of the accelerator opening degree θacc) during running on a flat road is obtained by experimentation or determined by an appropriate design theory, and is stored as a relationship map between the reference angular acceleration αst and the accelerator opening degree θacc as a parameter. It is noted that the above-described determination can be made, for example, in a case in which an accelerating operation is executed during running of the vehicle 10 on a road surface on which the vehicle 10 is to be parked, more specifically, in a case in which the accelerating operation is executed shortly before the vehicle 10 is stopped.

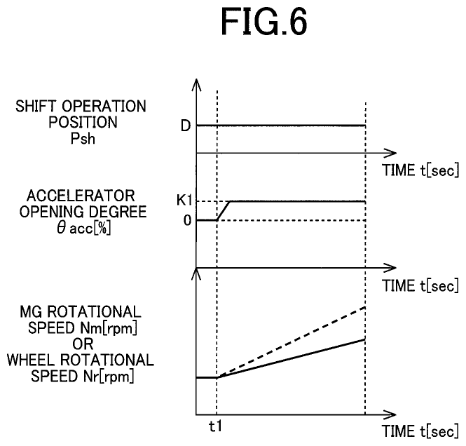

FIG. 6 is a time chart showing the behavior of the vehicle 10 during running of the vehicle 10 on an upward sloped road. In FIG. 6, horizontal axes represent a time t [sec], while vertical axes represent the shift operation position Psh, the accelerator opening degree θacc [%], and the MG rotational speed Nm [rpm] or the wheel rotational speed Nr [rpm].

In FIG. 6, a time point t1 is a point to time at which the accelerator pedal 106 is depressed. Then, the accelerator opening degree θacc is increased, and the accelerator opening degree θacc is kept at a predetermined value K1 after elapse of a predetermined time from the time point t1. In this instance, the MG rotational speed Nm or the wheel rotational speed Nr indicated by solid line is increased while the accelerator opening degree θacc is kept at the predetermined value K1. Further, the MG rotational speed Nm or the wheel rotational speed Nr indicated by broken line represents the MG rotational speed Nm or the wheel rotational speed Nr based on the reference angular acceleration αst, i.e., the MG rotational speed Nm or the wheel rotational speed Nr when the accelerating operation is executed during running of the vehicle 10 on a flat road. In the time chart of FIG. 6 that shows the behavior of the vehicle 10 during running of the vehicle 10 on an upward sloped road, the MG angular acceleration αm and the wheel angular acceleration αr are lower than the reference angular acceleration αst, so that an amount of deviation of the MG rotational speed Nm or the wheel rotational speed Nr indicated by solid line from the MG rotational speed Nm or the wheel rotational speed Nr indicated by broken line, is increased with elapse of the time t. It is noted that, although not shown, where the road surface is a downward sloped road, the MG angular acceleration αm and the wheel angular acceleration αr are higher than the reference angular acceleration αst, so that the MG rotational speed Nm or the wheel rotational speed Nr indicated by solid line is higher than a reference speed Nst indicated by broke like.

Further, whether the road surface is sloped or not and the direction of the road gradient θ can be determined, for example, based on the MG angular acceleration am or the wheel angular acceleration αr, relative to an operation amount of the brake pedal 108. It is noted that the MG angular acceleration αm and the wheel angular acceleration αr are both negative values when a braking operation is executed.

Where the MG angular acceleration αm or the wheel angular acceleration αr with a predetermined operation amount of the brake pedal 108 during running of the vehicle 10 on a flat road is set to a reference angular acceleration αst, the MG angular acceleration αm or the wheel angular acceleration αr with the same predetermined operation amount of the brake pedal 108 during running of the vehicle 10 on an upward sloped road is higher on negative side than the reference angular acceleration αst. That is, an absolute value of each of the MG angular acceleration αm and the wheel angular acceleration αr is higher than an absolute value of the reference angular acceleration αst. On the other hand, the MG angular acceleration αm or the wheel angular acceleration αr with the same predetermined operation amount of the brake pedal 108 during running of the vehicle 10 on a downward sloped road is lower on negative side than the reference angular acceleration αst. That is, an absolute value of each of the MG angular acceleration αm and the wheel angular acceleration αr is lower than the absolute value of the reference angular acceleration αst.

The slope determining portion 122 calculates the MG angular acceleration am of the electric motor MG, based on the change of the MG rotational speed Nm during running of the vehicle 10, and determines that the road surface is a sloped road when an absolute value of the calculated MG angular acceleration αm is deviated from an absolute value of the reference angular acceleration αst (that is predetermined for the same operation amount of the brake pedal 108) during running on a flat road, by at least a predetermined value. In this instance, the slope determining portion 122 determines that the sloped road is sloped upward when the absolute value of the MG angular acceleration αm is higher than the absolute value of the reference angular acceleration αst, and determines that the sloped road is sloped downward when the absolute value of the MG angular acceleration αm is lower than the absolute value of the reference angular acceleration αst.

Alternatively, the slope determining portion 122 calculates the wheel angular acceleration αr, based on the change of the wheel rotational speed Nr during running of the vehicle 10, and determines that the road surface is a sloped road when an absolute value of the calculated wheel angular acceleration αr is deviated from an absolute value of the reference angular acceleration αst (that is predetermined for the same operation amount of the brake pedal 108) during running on a flat road, by at least a predetermined value. In this instance, the slope determining portion 122 determines that the sloped road is sloped upward when the absolute value of the wheel angular acceleration αr is higher than the absolute value of the reference angular acceleration αst, and determines that the sloped road is sloped downward when the absolute value of the wheel angular acceleration αr is lower than the absolute value of the reference angular acceleration αst. The reference angular acceleration αst (that is predetermined for each level of the operation amount of the brake pedal 108) during running on a flat road is obtained by experimentation or determined by an appropriate design theory, and is stored as a relationship map between the reference angular acceleration αst and the operation amount of the brake pedal 108 as a parameter. The operation amount of the brake pedal 108 may be replaced by another brake operation amount or a value related to the brake operation amount, such as the stroke amount STbrk of the brake pedal 108, the master-cylinder hydraulic pressure Pm of the brake master cylinder and the wheel hydraulic pressure Pwl of the wheel cylinder. It is noted that the above-described determination can be made, for example, in a case in which a braking operation is executed during running of the vehicle 10 on a road surface on which the vehicle 10 is to be parked, more specifically, in a case in which the braking operation is executed shortly before the vehicle 10 is stopped.

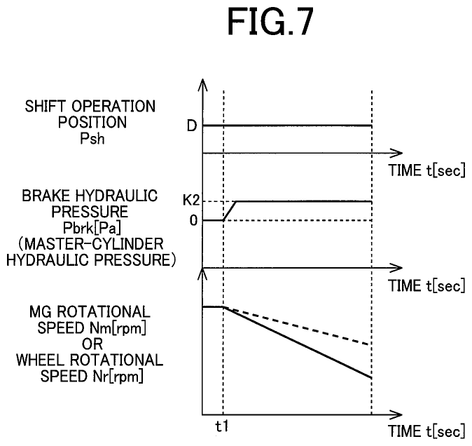

FIG. 7 is a time chart showing the behavior of the vehicle 10 when the vehicle 10 is to be stopped on an upward sloped road. In FIG. 7, horizontal axes represent a time t [sec], while vertical axes represent the shift operation position Psh, the brake hydraulic pressure Pbrk [Pa], and the MG rotational speed Nm [rpm] or the wheel rotational speed Nr [rpm].

In FIG. 7, a time point t1 is a point to time at which the brake pedal 108 is depressed. Then, the brake hydraulic pressure Pbrk (e.g., the master-cylinder hydraulic pressure Pm of the brake master cylinder) corresponding to the braking operation amount is increased, and the brake hydraulic pressure Pbrk is kept at a predetermined value K2 after elapse of a predetermined time from the time point t1. In this instance, the MG rotational speed Nm or the wheel rotational speed Nr indicated by solid line is reduced while the brake hydraulic pressure Pbrk is kept at the predetermined value K2. Further, the MG rotational speed Nm or the wheel rotational speed Nr indicated by broken line represents the MG rotational speed Nm or the wheel rotational speed Nr based on the reference angular acceleration αst, i.e., the MG rotational speed Nm or the wheel rotational speed Nr when the braking operation is executed during running of the vehicle 10 on a flat road. In the time chart of FIG. 7 that shows the behavior of the vehicle 10 when the vehicle 10 is to be stopped on an upward sloped road, an absolute value of each of the MG angular acceleration αm and the wheel angular acceleration αr is higher on negative side than the reference angular acceleration αst, so that a rate of reduction of the MG rotational speed Nm or the wheel rotational speed Nr indicated by solid line is higher than that of the MG rotational speed Nm or the wheel rotational speed Nr indicated by broken line. It is noted that, although not shown, where the road surface is a downward sloped road, the absolute value of each of the MG angular acceleration αm and the wheel angular acceleration αr is lower than the absolute value of the reference angular acceleration αst, so that the rate of reduction of the MG rotational speed Nm or the wheel rotational speed Nr indicated by solid line is lower than that of the MG rotational speed Nm or the wheel rotational speed Nr indicated by broken line.

Further, whether the road surface is sloped or not and the direction of the road gradient θ can be also determined directly based on the road gradient θ and the direction of the road gradient θ, which are detected by the slope sensor 102. That is, when the vehicle 10 is stopped, the slope determining portion 122 determines whether the road surface is sloped or not and determines the direction of the road gradient θ, based on the road gradient θ detected by the slope sensor 102.

Still further, whether the road surface is sloped or not and the direction of the road gradient θ can be determined also based on the stroke amount STf of the front axle suspension 144 and the stroke amount STr of the rear axle suspension 150, which are detected by the front-axle-suspension stroke sensor 94 (hereinafter referred to as “front-suspension stroke sensor 94”) and the rear-axle-suspension stroke sensor 96 (hereinafter referred to as “rear-suspension stroke sensor 96”), respectively.

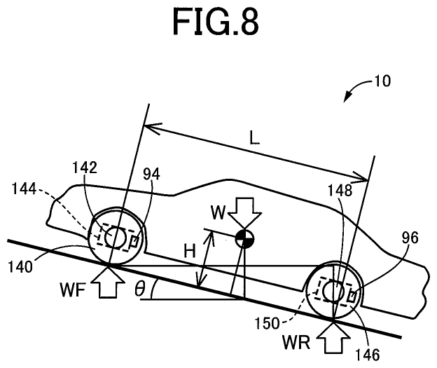

FIG. 8 is a view showing a state in which the vehicle 10 is stopped on an upward sloped road, for example. As shown in FIG. 8, a front axle 142 of a front wheel 140 (wheel) is supported by a front axle suspension 144 represented by a broken line. The front axle suspension 144 is provided with the front-suspension stroke sensor 94 that is configured to detect the stroke amount STf that is an amount of displacement of the front axle suspension 144. Further, a rear axle 148 of a rear wheel 146 (wheel) is supported by a rear axle suspension 150 represented by a broken line. The rear axle suspension 150 is provided with the rear-suspension stroke sensor 96 that is configured to detect the stroke amount STr that is an amount of displacement of the rear axle suspension 150. It is noted that the front wheel 140 (wheel) and/or the rear wheel 146 (wheels) serve as the drive wheel 12.

In the state in which the vehicle 10 is stopped on the upward sloped road, as shown in FIG. 8, a weight Wmv, which is calculated by the following formula (1), is shifted from the front axle 142 to the rear axle 148. In the formula (1), “W” represents an overall weight of the vehicle 10, “H” represents a height of a center of gravity of the vehicle 10 from the road surface, and “θ” represents the road gradient. In the state in which the vehicle 10 is stopped on the upward sloped road, since the weight Wmv calculated by the following formula (1) is shifted from the front axle 142 to the rear axle 148, namely, a weight acting on the front axle 142 is reduced by the weight Wmv while a weight acting on the rear axle 148 is increased by the weight Wmv, a contraction amount of the front axle suspension 144 is reduced while a contraction amount of the rear axle suspension 150 is increased. On the other hand, in a state in which the vehicle 10 is stopped on a downward sloped road, the weight Wmv calculated by the following formula (1) is shifted from the rear axle 148 to the front axle 142, namely, the weight acting on the front axle 142 is increased by the weight Wmv while the weight acting on the rear axle 148 is reduced by the weight Wmv, so that the contraction amount of the front axle suspension 144 is increased while the contraction amount of the rear axle suspension 150 is reduced.

Wmv=(W×H×tan θ)/L (1)

Thus, whether the road surface is sloped or not and the direction of the road gradient θ can be determined, based on the stroke amount STf of the front axle suspension 144 and the stroke amount STr of the rear axle suspension 150.

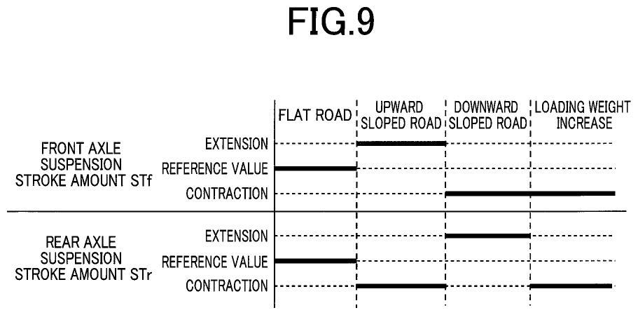

FIG. 9 is a view showing a relationship between a state of the road surface and the stroke amount STf of the front axle suspension 144 and also a relationship between the state of the road surface and the stroke amount STr of the rear axle suspension 150. In FIG. 9, a state in which the vehicle 10 is on a flat road is a reference state. Specifically, each of the stroke amount STf of the front axle suspension 144 and the stroke amount STf of the rear axle suspension 150 when the vehicle 10 is on the flat road is indicated as a reference value. When the vehicle 10 is on an upward sloped road, the weight acting on the front axle suspension 144 is smaller than when the vehicle 10 is on the flat road while the weight acting on the rear axle suspension 150 is larger than when the vehicle 10 is on the flat road, so that the stroke amount STf of the front axle suspension 144 is changed to extension side with respect to the reference value while the stroke amount STr of the rear axle suspension 150 is changed to contraction side with respect to the reference value. Further, when the vehicle 10 is on a downward sloped road, the weight acting on the front axle suspension 144 is larger than when the vehicle 10 is on the flat road while the weight acting on the rear axle suspension 150 is smaller than when the vehicle 10 is on the flat road, so that the stroke amount STf of the front axle suspension 144 is changed to contraction side with respect to the reference value while the stroke amount STr of the rear axle suspension 150 is changed to expansion side with respect to the reference value.

Thus, the slope determining portion 122 determines that the road surface is sloped and the sloped road is sloped upward, in a case in which the stroke amount STf of the front axle suspension 144 is changed to extension side with respect to the reference value while the stroke amount STr of the rear axle suspension 150 is changed to contraction side with respect to the reference value. Further, the slope determining portion 122 determines that the road surface is sloped and the sloped road is sloped downward, in a case in which the stroke amount STf of the front axle suspension 144 is changed to contraction side with respect to the reference value while the stroke amount STr of the rear axle suspension 150 is changed to extension side with respect to the reference value. Thus, it is determined that the vehicle 10 is on a sloped road in a case in which the direction of change of the stroke amount STf of the front axle suspension 144 and the direction of change of the stroke amount STr of the rear axle suspension 150 are different from each other. Further, it is determined whether the sloped road is sloped upwardly or sloped downwardly, depending on the direction of change of the stroke amount STf of the front axle suspension 144 and the direction of change of the stroke amount STr of the rear axle suspension 150.

When a passenger gets on the vehicle 10 or a cargo is loaded on the vehicle 10, each of the stroke amount STf of the front axle suspension 144 and the stroke amount STr of the rear axle suspension 150 is changed to contraction side with respect to the reference value. When the passenger gets off the vehicle 10 or the cargo is unloaded from the vehicle 10, each of the stroke amount STf of the front axle suspension 144 and the stroke amount STr of the rear axle suspension 150 is changed to extension side with respect to the reference value. Thus, in a case in which the direction of change of the stroke amount STf of the front axle suspension 144 and the direction of change of the stroke amount STr of the rear axle suspension 150 are the same, it is determined that a weight change has occurred due to a passenger or a cargo, for example.

Moreover, whether the road surface is sloped or not and the direction of the road gradient θ can be determined also based on the oil level Lo that is the height of the surface of the oil stored in the oil pan 152 of the power transmission apparatus 14, which is detected by the oil level sensor 98. In the present embodiment, the oil level sensor 98 is disposed in a rear portion of the oil pan 152 in a longitudinal direction of the vehicle 10.

FIG. 10 is a view showing a state of the oil stored in the oil pan 152 disposed in a lower portion of the power transmission apparatus 14 when the vehicle 10 is on a flat road. FIG. 11 is a view showing a state of the oil stored in the oil pan 152 when the vehicle 10 is on an upward sloped road.

The oil level Lo when the vehicle 10 is on the flat road as shown in FIG. 10 is indicated as a reference oil level Lst. When the vehicle 10 is stopped on the upward sloped road, the oil level Lo is changed as the oil pan 152 is inclined together with the vehicle 10, as shown in FIG. 11. Specifically, when the vehicle 10 is on the upward sloped road, the oil level Lo is higher than the reference oil level Lst. On the other hand, although not shown, when the vehicle 10 is on a downward sloped road, the oil level Lo is lower than the reference oil level Lst.

The slope determining portion 122 determines that the vehicle 10 is on a sloped road when the oil level Lo detected by the oil level sensor 98 is deviated from the reference oil level Lst by at least a predetermined value. In this instance, the slope determining portion 122 determines that the road surface is sloped upward when the oil level Lo is higher than the reference oil level Lst, and determines that the road surface is sloped downward when the oil level Lo is lower than the reference oil level Lst.

The slope determining portion 122 makes the above-described determinations as to the sloped road, by one of the above-described determination methods or by combining two or more of the above-described determination methods. For example, it is possible to predetermine a priority of each of the determination methods, and to make the determinations by a selected one of the determination methods which is selected in accordance with the predetermined priority. Specifically, when one of the determination methods having the highest priority is difficult to be executed, another one of the determination methods having the second highest priority is executed. When the another one of the determination methods having the second highest priority is difficult to be executed, still another one of the determination methods having the third highest priority is executed. Thus, the determination methods with higher priority are executed sequentially. It is noted that the priority of each of the determination methods is determined by taking account of, for example, whether reliability of determination by each method is high and/or whether an additional sensor or the like is unrequired for each method. For example, the determination methods, which are to be executed to make the determinations depending on presence or absence of the vehicle 10 upon parking of the vehicle 10, are able to determine the direction of the road gradient θ without error and without requiring the additional sensor, and accordingly are given highest or higher priority.

When it is determined that the road surface is the sloped road, the start-stage MG-torque controlling portion 124 causes the electric motor MG to output the MG torque Tm corresponding to the direction of the road gradient θ. That is, when the road surface is the sloped road, the start-stage MG-torque controlling portion 124 determines a rotational direction of the electric motor MG against a direction of rotation of the drive wheels 12 due to the road gradient θ, based on the direction of the road gradient θ. Then, the start-stage MG-torque controlling portion 124 causes the electric motor MG to output the MG torque Tm acting in the determined rotational direction against the direction of rotation of the drive wheels 12. For example, when the road surface is the upward sloped road, namely, when the drive wheels 12 are rotated in reverse rotation direction, the electric motor MG is caused to output the MG torque Tm acting in forward rotation direction that is opposite to the reverse rotation direction of the drive wheels 12. Further, when the road surface is the downward sloped road, namely, when the drive wheels 12 are rotated in forward rotation direction, the electric motor MG is caused to output the MG torque Tm acting in reverse rotation direction that is opposite to the forward rotation direction of the drive wheels 12. When starting causing the electric motor MG to output the MG torque Tm, the start-stage MG-torque controlling portion 124 keeps increasing a magnitude of the MG torque Tm of the electric motor MG until rotation of the electric motor MG is detected.

When the MG torque Tm is outputted from the electric motor MG, the MG-rotation determining portion 126 determines whether the electric motor MG has been rotated or not. The MG-rotation determining portion 126 determines that the electric motor MG has been rotated, when an amount of change of the MG rotational angle θm from a point of time at which the MG torque Tm is outputted becomes at least a threshold value θx. The threshold value θx is obtained by experimentation or determined by an appropriate design theory, such that it can be determined that the electric motor MG has been determined when the amount of change of the MG rotational angle θm becomes at least the threshold value θx. In this instance, since the parking lock mechanism 22 is placed in the parking lock state (parking lock ON), the electric motor MG can be rotated only by a rotational angle corresponding to a gap (backlash) between the parking gear 28 of the parking lock mechanism 22 and the lock tooth 30 of the parking pawl 32. Therefore, the threshold value θx is set to a very small value smaller than a rotational angle corresponding to the above-described gap (backlash).

When the rotation of the electric motor MG has been detected, the actuator controlling portion 128 causes the actuator 38 to be driven to switch the parking lock mechanism 22 to the parking unlock state (parking lock OFF). That is, with the parking pawl 32 being pivoted by operation of the actuator 38, the lock tooth 30 is moved to a releasing position in which the meshing of the lock tooth 30 with the parking gear 28 is released. In this instance, when the actuator 38 starts to be operated, the parking gear 28 is rotated by the MG torque Tm of the electric motor MG, and the load acting between tooth surfaces of the parking gear 28 and the lock tooth 30 of the parking pawl 32 is zero or is close to zero, so that the parking lock mechanism 22 can be switched to the non-parking state (parking lock OFF) without increasing the load applied to the actuator 38. In this connection, it is possible to reduce required output of the actuator 38 and accordingly to reduce an output capacity and a size of the actuator 38.

Further, in the present embodiment, unlike the prior art, the process of driving the actuator 38 and determining whether it is difficult to switch the parking lock mechanism 22 to the parking unlock state is not required, so that the number of times at which the actuator 38 is operated is not increased, and accordingly the power consumption is also reduced. Still further, the load applied to the actuator 38 is reduced whereby deterioration in durability of the actuator 38 is also suppressed. Moreover, since the torsion torque Ttw is cancelled when the parking gear 28 is rotated, the shock caused upon release of the torsion torque Ttw when the meshing of the lock tooth 30 with the parking gear 28 is released is suppressed.

Further, in the present embodiment, when the MG torque Tm is outputted from the electric motor MG, the MG torque Tm is merely increased until the rotation of the electric motor MG is detected, so that there is no need to accurately control the MG torque Tm. For accurately controlling the MG torque Tm, it would be necessary to accurately detect the road gradient θ. However, the accurate detection of the road gradient θ cannot be made in the above-described determination methods. In the present embodiment, since only the direction of the road gradient θ needs to be known, the control is simplified and a load on the electronic control apparatus 20 is reduced. It is noted that, after the parking lock mechanism 22 is switched to the parking unlock state, the shift range of the vehicle 10 is switched from the P range to another shift range such as a forward driving range (D range) or a reverse driving range (R range), depending on the shift operation position Psh of the shift lever 104.

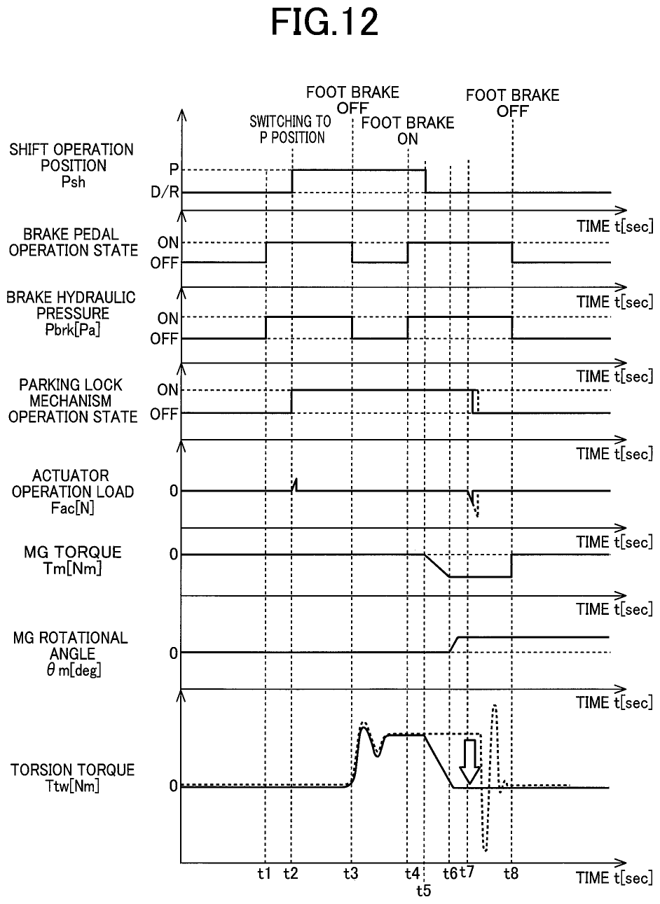

FIG. 12 a time chart showing the behavior of the vehicle 10, based on control operations performed by the electronic control apparatus 20, wherein the time chart is from parking of vehicle 10 on a sloped road until start of vehicle 10. In FIG. 12, horizontal axes represent a time t [sec], while vertical axes represent the shift operation position Psh, the operation state of the brake pedal 108, the brake hydraulic pressure Pbrk [Pa], the operation state of the parking lock mechanism 22, the operation load Fac [N] on the actuator 38, the MG torque Tm [Nm] of the electric motor MG, the MG rotational angle θm [deg] of the electric motor MG and the torsion torque Ttw [Nm], as seen sequentially from top to down. It is noted that the brake hydraulic pressure Pbrk corresponds to the master-cylinder hydraulic pressure Pm of the brake master cylinder or the wheel hydraulic pressure Pwl of the brake wheel cylinder.

In FIG. 12, a time point t1 represent a point of time at which the brake pedal 108 is depressed whereby the brake hydraulic pressure Pbrk is increased. At a time point t2, the shift operation position Psh is switched to the P position from the D position or the R position, after the vehicle 10 has been stopped. In response to the switch of the shift operation position Psh to the P position, the actuator 38 is operated such that the parking lock mechanism 22 is switched to the parking lock state (parking lock ON). At a time point t3, the depression of the brake pedal 108 is released after the parking lock mechanism 22 has been switched to the parking lock state at the time point t2, whereby the brake hydraulic pressure Pbrk is reduced. In this instance, since the drive wheels 12 are allowed to be rotated depending on the road gradient θ, whereby the torsion torque Ttw is generated as a rotary member (such as a drive shaft) constituting the power transmission path between the parking gear 28 and the drive wheels 12 is twisted or torsioned.

At a time point t4, for starting the vehicle 10, the brake pedal 108 is depressed whereby the brake hydraulic pressure Pbrk is increased. At a point of time t5 after elapse of a predetermined time from the time point t4, the shift operation position Psh is switched from the P position to the D position or R position. In this instance, since the road surface on which the vehicle 10 is stopped is a sloped road, the electric motor MG is caused to output the MG torque Tm acting in an opposite rotational direction opposite to the direction of rotation of the drive wheels 12 due to road gradient θ. As the MG torque Tm is outputted, the torsion torque Ttw is reduced. At a time point t6 at which the torsion torque Ttw has become not larger than a predetermined value as a result of increase of the MG torque Tm, the electric motor MG starts to be rotated whereby the MG rotational angle θm is increased. In this instance, the rotation of the electric motor MG is detected and the increase of the MG torque Tm is stopped. Further, as a result of detection of the rotation of the electric motor MG, at a time point t7, the actuator 38 of the parking lock mechanism 22 is driven whereby the parking lock mechanism 22 is switched to the parking unlock state (parking lock OFF). At this time point t7, since the torsion torque Ttw has been already cancelled, it is possible to suppress shock that could be caused due to release of the torsion torque Ttw when the meshing of the lock tooth 30 with the parking gear 28 is released. It is noted that the torsion torque Ttw and the operation load Fac indicated by broken lines represent the behavior of the vehicle 10 in a case in which the MG torque Tm is not outputted from the electric motor MG. In such a case without the MG torque Tm outputted from the electric motor MG, the operation load Fac on the actuator 38 is increased as indicated by the broken line, and the shock is generated upon release of the torsion torque Ttw when the meshing of the lock tooth 30 with the parking gear 28 is released because the torsion torque Ttw is kept high, as indicated by the broke line. Then, at a time point t8, the depression of the brake pedal 108 is released whereby the brake hydraulic pressure Pbrk is reduced, and the control of output of the MG torque Tm is completed.

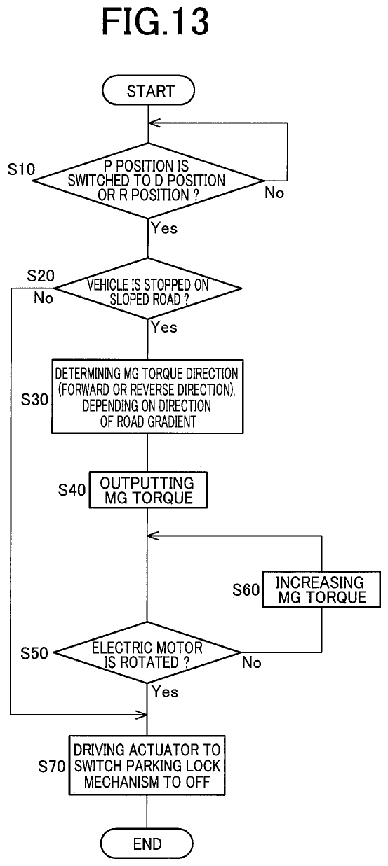

FIG. 13 is a flow chart showing a control routine executed by the electronic control apparatus 20, for appropriately switching the parking lock mechanism 22 to the parking unlock state (parking lock OFF) when the vehicle 10 is to be started on a sloped road. This control routine is executed when the vehicle 10 is to be started.

This control routine is initiated with step S10 corresponding to control function of the shift-lever switch determining portion 120, which is implemented to determine whether the shift operation position Psh of the shift lever 104 has been switched from the P position to the D position or R position. When a negative determination is made at step S10, the control flow goes back to step S10 whereby step S10 is repeatedly implemented until an affirmative determination is made at step S10. When an affirmative determination is made at step S10, step S20 corresponding to control function of the slope determining portion 122 is implemented to determine whether a road surface on which the vehicle 10 is stopped is sloped or not. When a negative determination is made at step S20, the control flow goes to step S70 corresponding to control function of the actuator controlling portion 128, which is implemented to drive the actuator 38 to switch the parking lock mechanism 22 to the parking unlock state (parking lock OFF). When an affirmative determination is made at step S20, step S30 corresponding to control function of the slope determining portion 122 is implemented to determine a direction of the MG torque Tm that is to be outputted from the electric motor MG. That is, the above-described opposite rotational direction opposite to the direction of rotation of the drive wheels 12 due to the road gradient θ, is determined. Then, at step S40 corresponding to control function of the start-stage MG-torque controlling portion 124, the MG torque Tm, whose direction has been determined at step S30, is outputted from the electric motor MG. Step S40 is followed by step S50 corresponding to control function of the MG-rotation determining portion 126, which is implemented to determine whether the electric motor MG has been rotated or not. When a negative determination is made at step S50, step S60 corresponding to control function of the start-stage MG-torque controlling portion 124 is implemented to increase a value of the MG torque Tm outputted by the electric motor MG. On the other hand, when an affirmative determination is made at step S50, the control flow goes to step S70 corresponding to control function of the actuator controlling portion 128, which is implemented to drive the actuator 38 to switch the parking lock mechanism 22 to the parking unlock state (parking lock OFF).

As described above, in the present embodiment, when the shift operation position Psh is switched from the P position to the D position or R position, the electric motor MG is caused to output the MG torque Tm acting in the opposite rotational direction opposite to the direction of the rotation of the drive wheels 12 due to the road gradient θ, and the MG torque Tm outputted by the electric motor MG is increased until the rotation of the electric motor MG is detected. Therefore, even in a case in which the vehicle 10 is stopped on a sloped road so that a load acting between the parking gear 28 and the lock tooth 30 meshing with the parking gear 28 is large, the load acting between the parking gear 28 and the lock tooth 30 is reduced with the MG torque Tm of the electric motor MG being increased until the rotation of the electric motor MG is detected, and becomes zero or substantially zero when the rotation of the electric motor MG is detected. Thus, the load on the actuator 38 is reduced because the meshing of the lock tooth 30 with the parking gear 28 is released in the parking lock mechanism 22 in this state in which the load acting between the parking gear 28 and the lock tooth 30 is zero or substantially zero. Further, the torsion torque Ttw caused in the power transmission path between the parking gear 28 and the drive wheels 12 is cancelled by the rotation of the electric motor MG, so that it is possible to suppress a shock, which could be caused due to the torsion torque Ttw in the power transmission path, when the vehicle 10 is started. Still further, in this control apparatus 20, a process of driving the actuator 38 and determining whether it is possible to release the meshing of the lock tooth 30 with the parking gear 28 is not required so that a number of times at which the actuator 38 is operated is not increased, and accordingly an electric power consumption is also reduced. Moreover, the load applied to the actuator 38 is reduced whereby deterioration in durability of the actuator 38 is also suppressed.

Further, in the present embodiment, after the parking lock mechanism 22 is switched to the parking lock state in process of parking the vehicle 10, whether the road surface is sloped or not and the direction of the road gradient θ can be accurately determined based on the change of the MG rotational angle θm of the electric motor MG or the change of the wheel rotational angle θr of the wheel of the vehicle 10, which are caused upon release of the depression of the brake pedal 108 of the vehicle 10. Further, when the shift operation position Psh is switched from the P position to the D position or R position, it is determined whether the road surface is sloped or not, and, when the road surface is sloped, the electric motor MG is caused to output the MG torque Tm acting in the opposite rotational direction opposite to the direction of the rotation of the drive wheels 12 due to the road gradient θ. Therefore, when it is determined that the road surface is flat, the electric motor MG is avoided from outputting the MG torque Tm whereby the electric power consumption is reduced.

While the preferred embodiment of this invention has been described in detail by reference to the drawings, it is to be understood that the invention may be otherwise embodied.

For example, in the above-described embodiment, the vehicle 10 is the electric vehicle having the drive power source in the form of the electric motor MG for enabling the vehicle 10 to run. However, the present invention is applicable also to a hybrid electric vehicle having an engine and an electric motor both of which serve as drive power sources for enabling the vehicle 10 to run. Where the vehicle has the engine, it is also possible to provide an engine-oil level sensor configured to detect a height of a surface of an oil stored in an oil pan in the engine, so that the direction of the road gradient θ can be determined based on the height of the oil surface detected by the engine-oil level sensor.

Further, in the above-described embodiment, the MG angular acceleration am of the electric motor MG is calculated based on change of the MG rotational speed Nm that is constantly detected. However, it is also possible to provide an angular acceleration sensor in the electric motor MG so that the MG angular acceleration am can be detected directly by the angular acceleration sensor. Similarly, in the above-described embodiment, the wheel angular acceleration αr of the wheel is calculated based on change of the wheel rotational speed Nr that is constantly detected. However, it is possible to provide an angular acceleration sensor for the wheel so that the wheel angular acceleration αr can be detected directly by the angular acceleration sensor.

Further, in the above-described embodiment, whether the road surface (on which the vehicle 10 is to be parked) is sloped or not and the direction of the road gradient θ are determined based on the MG angular acceleration αm of the electric motor MG or the wheel angular acceleration αr of the wheel, relative to the accelerator opening degree θacc. However, whether the road surface is sloped or not and the direction of the road gradient θ may be determined also based on the MG torque Tm of the electric motor MG that is detected by the MG torque sensor 88.

Further, in the above-described embodiment, there has been described a case in which the shift operation position Psh is switched from the P position to a running position such as the D position and R position. However, the present invention is applicable also to a case in which the shift operation position Psh is switched to, for example, N position in place of the running position.

Further, in the above-described embodiment, the parking lock mechanism 22 is switched to the parking lock state by causing the parking pawl 32 to be pivoted through the cam mechanism 36 by operation of the actuator 38. However, this arrangement is not essential. For example, the actuator 38 and the parking pawl 32 may be connected directly to each other. The present invention is applicable to any structure capable of switching the parking lock mechanism 22 to the parking lock state with the parking pawl 32 being pivoted by the actuator 38.

While the preferred embodiment of this invention has been described in detail by reference to the drawings, it is to be understood the embodiment described above is given for illustrative purpose only, and that the present invention may be embodied with various modifications and improvements which may occur to those skilled in the art.

### NOMENCLATURE OF ELEMENTS

10: vehicle
12: drive wheel (wheel)
20: electronic control apparatus (control apparatus)
22: parking lock mechanism
28: parking gear
30: lock tooth
38: actuator
108: brake pedal
MG: electric motor

What is claimed is:

1. A control apparatus for a vehicle that includes (i) drive wheels, (ii) an electric motor serving as a drive power source and (iii) a parking lock mechanism configured to mechanically stop rotation in a power transmission path between the electric motor and the drive wheels, wherein the parking lock mechanism includes (iii-1) a parking gear provided in the power transmission path, (iii-2) a lock tooth that is to mesh with the parking gear and (iii-3) an actuator configured to move the lock tooth, and wherein, when a shift operation position is switched to a parking position, the lock tooth is moved by the actuator to a meshing position to mesh with the parking gear whereby the parking lock mechanism is switched to a parking lock state in which rotation of the parking gear is inhibited by the lock tooth meshing with the parking gear,
wherein the control apparatus is configured, when the shift operation position is switched from the parking position to another position in a state in which the vehicle is stopped, to cause the electric motor to output a torque acting in an opposite rotational direction opposite to a direction of rotation of the drive wheels due to a gradient of a road surface, and to increase the torque outputted by the electric motor until rotation of the electric motor is detected.

2. The control apparatus according to claim 1,
wherein the control apparatus is configured, when the rotation of the electric motor is detected, to cause the actuator to move the lock tooth to a releasing position in which meshing of the lock tooth with the parking gear is released.

3. The control apparatus according to claim 1,
wherein the control apparatus is configured to determine the opposite rotational direction in which the outputted torque is to act, based on a direction of the gradient of the road surface, and
wherein the control apparatus is configured, after the parking lock mechanism is switched to the parking lock state in process of parking the vehicle, to determine the direction of the gradient of the road surface, based on a change of a rotational angle of the electric motor or a change of a rotational angle of a wheel of the vehicle, which are caused upon release of depression of a brake pedal of the vehicle.

4. The control apparatus according to claim 1,
wherein the control apparatus is configured, when the shift operation position is switched from the parking position to the other position, to determine whether the road surface is sloped or not, and
wherein the control apparatus is configured, when the road surface is sloped, to cause the electric motor to output the torque acting in the opposite rotational direction opposite to the direction of the rotation of the drive wheels due to the gradient of the road surface.
